(19) United States
(12) Patent Application Publication
(10) Pub. No.: US 2009/0320285 A1
(43) Pub. Date: Dec. 31, 2009

(54) EDM MACHINING AND METHOD TO MANUFACTURE A CURVED ROTOR BLADE RETENTION SLOT

(76) Inventors: Tahany Ibrahim El-Wardany, Bloomfield, CT (US); Gary Paul Zadrozny, East Glastonbury, CT (US); Leo A. Hoffman, Vernon, CT (US); Peter G. Smith, Wallingford, CT (US); Joseph B. Wysocki, Somers, CT (US)

Correspondence Address: CARLSON, GASKEY & OLDS/PRATT & WHITNEY, 400 WEST MAPLE ROAD, SUITE 350, BIRMINGHAM, MI, 48009, US

(21) Appl. No.: 12/164,350

(22) Filed: Jun. 30, 2008

(51) Int. Cl. B23P 15/00

(52) U.S. Cl. 29/888.025

(57) ABSTRACT

A method of machining a curved blade retention slot with electron discharge machining.

### BACKGROUND

The present invention relates to a gas turbine engine, and more particularly to process tooling and procedures to machine curved blade retention slots within a rotor disk.

A gas turbine has a multiple of rotor blades that may be secured to a multiple of rotor disks. The blade/disk attachment configurations utilize a convoluted attachment section complementary to a convoluted slot in the rotor disk periphery.

Various manufacturing methods have been used or proposed to efficiently form the blade retention slots. The most common method of manufacturing blade retention slots is a broaching process. Although effective, broaching of nickel based super alloys objects such as a rotor disk may induce defects including material strain hardening, surface microstructure alteration and slot deformation. Aside from the relatively high cost of the broach tools and limited tool life, part scrap rate may increase due to defected surface integrity. Furthermore, broaching processes general produce straight rather than convoluted curved slots.

Curved slot attachment configurations in highly cambered turbine airfoils help minimize platform overhang and optimize stress distribution to reduce centrifugal forces, bending moments, vibrations and peak stresses. Curved slot attachment configurations, however, may be difficult to produce and are not readily produced through broaching processes.

### SUMMARY

A method of machining a blade retention slot according to an exemplary aspect of the present invention includes: electron discharge machining a straight blade retention slot then electron discharge machining at least one side of the straight blade retention slot to generate a curved side of the blade retention slot.

### BRIEF DESCRIPTION OF THE DRAWINGS

The various features and advantages of this invention will become apparent to those skilled in the art from the following detailed description of the disclosed non-limiting embodiments. The drawings that accompany the detailed description can be briefly described as follows:

FIG. 1 is a schematic illustration of a gas turbine engine;

FIG. 2 is a perspective view of a single rotor blade mounted to a rotor disk;

FIG. 3 is block diagram illustrating the methodology of one non-limiting embodiment may be utilized to manufacture the curved blade retention slot;

FIG. 4 is an expanded view of a section of a rotor disk illustrating a straight blade retention slot;

FIG. 5 is a front view of an EDM electrode with a curvature on each side which corresponds to a desired curved blade retention slot;

FIG. 6 is a schematic top view of a path for the EDM electrode of FIG. 5 to machine a desired curved blade retention slot;

FIG. 7 is a perspective view of a section of a rotor disk illustrating a curved blade retention slot;

FIG. 8 is block diagram illustrating the methodology of another non-limiting embodiment may be utilized to manufacture the curved blade retention slot;

FIG. 9 is an expanded perspective view of a section of a rotor disk illustrating a convex side of a curved blade retention slot;

FIG. 9A is a schematic view illustrating the EDM wire movement to machine the convex side of a curved blade retention slot with the EDM wire position held constant to illustrate relative movement of the EDM wire at a first segment;

FIG. 9B is a schematic view illustrating the EDM wire movement to machine the convex side of a curved blade retention slot with the EDM wire position held constant to illustrate relative movement of the EDM wire at a second segment;

FIG. 9C is a schematic view illustrating the EDM wire movement to machine the convex side of a curved blade retention slot with the EDM wire position held constant to illustrate relative movement of the EDM wire at a third segment;

FIG. 9D is a schematic view illustrating the EDM wire movement to machine the convex side of a curved blade retention slot with the EDM wire position held constant to illustrate relative movement of the EDM wire at a fourth segment;

FIG. 9E is a schematic view illustrating the EDM wire movement to machine the convex side of a curved blade retention slot with the EDM wire position held constant to illustrate relative movement of the EDM wire at a fifth segment;

FIG. 10 is an expanded perspective view of a section of a rotor disk illustrating a concave side of a curved blade retention slot and a multiple of EDM wire position illustrating contact lines with the straight blade retention slot between two contact point;

FIG. 10A is a schematic view illustrating the EDM wire movement to machine the concave side of a curved blade retention slot with the EDM wire position held constant to illustrate relative movement of the LDM wire at a first segment;

FIG. 10B is a schematic view illustrating the EDM wire movement to machine the concave side of a curved blade retention slot with the EDM wire position held constant to illustrate relative movement of the EDM wire at a second segment;

FIG. 10C is a schematic view illustrating the EDM wire movement to machine the concave side of a curved blade retention slot with the LDM wire position held constant to illustrate relative movement of the EDM wire at a third segment;

FIG. 10D is a schematic view illustrating the EDM wire movement to machine the concave side of a curved blade retention slot with the EDM wire position held constant to illustrate relative movement of the EDM wire at a fourth segment;

FIG. 11 is a line view of the straight blade retention slot discritized in the Y direction to facilitate definition of each segment of an EDM wire path which predict the required maximum and minimum EDM wire tilt angles within each segment.;

FIG. 12A is an expanded perspective view of a section of a rotor disk illustrating the convex side of a curved blade retention slot showing the 5-axis movement of the EDM wire tilt angles as the EDM wire transitions between each segment such as the segments illustrated in FIGS. 9A-9E; and

FIG. 12B is an expanded perspective view of a section of a rotor disk illustrating the convex side of the curved blade retention slot to illustrate the EDM wire feed direction for an AWJ feed direction as the EDM completes each set of segment such as the segments illustrated in FIGS. 9A-9E.

### DETAILED DESCRIPTION OF THE EXEMPLARY EMBODIMENTS

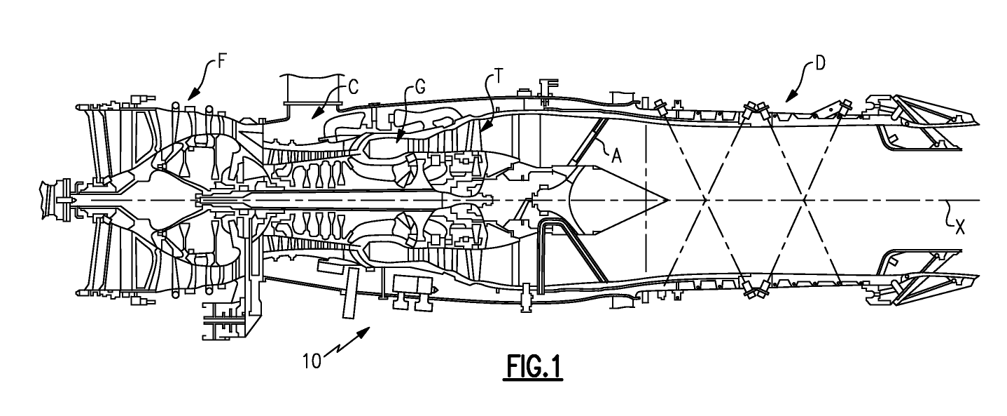

FIG. 1 schematically illustrates a gas turbine engine 10 which generally includes a fan section F, a compressor section C, a combustor section G, a turbine section T, an augmentor section A, and an exhaust duct assembly D. The compressor section C, combustor section G, and turbine section T are generally referred to as the core engine. An engine longitudinal axis X is centrally disposed and extends longitudinally through these sections. Although a particular engine configuration is illustrated and described in the disclosed embodiment, other engines will also benefit herefrom.

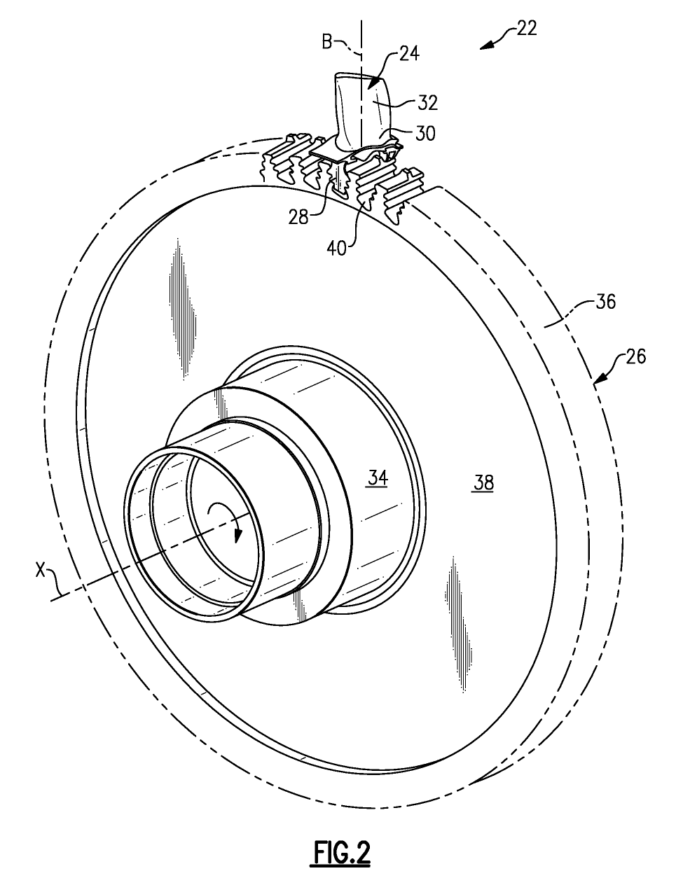

Referring to FIG. 2, a rotor assembly 22 such as that of a HPT (High Pressure Turbine disk assembly) of the gas turbine engine 10 is illustrated. It should be understood that a multiple of rotor disks may be contained within each engine section such as a fan section, a compressor section, and a turbine section. Although a particular rotor assembly 22 is illustrated and described in the disclosed embodiment, other sections which have other blades such as fan blades, low pressure turbine blades, high pressure turbine blades, high pressure compressor blades and low pressure compressor blades will also benefit herefrom.

The rotor assembly 22 includes a plurality of blades 24 circumferentially disposed around a rotor disk 26. Each blade 24 generally includes an attachment section 28, a platform section 30, and an airfoil section 32 along a radial axis B. The rotor disk 26 generally includes a hub 34, a rim 36, and a web 38 which extends therebetween. Each of the blades 24 is received within a blade retention slot 40 formed within the rim 36 of the rotor disk 26. The blade retention slot 40 includes a contour such as a fir-tree or bulb type which corresponds with a contour of the attachment section 28 to provide engagement therewith.

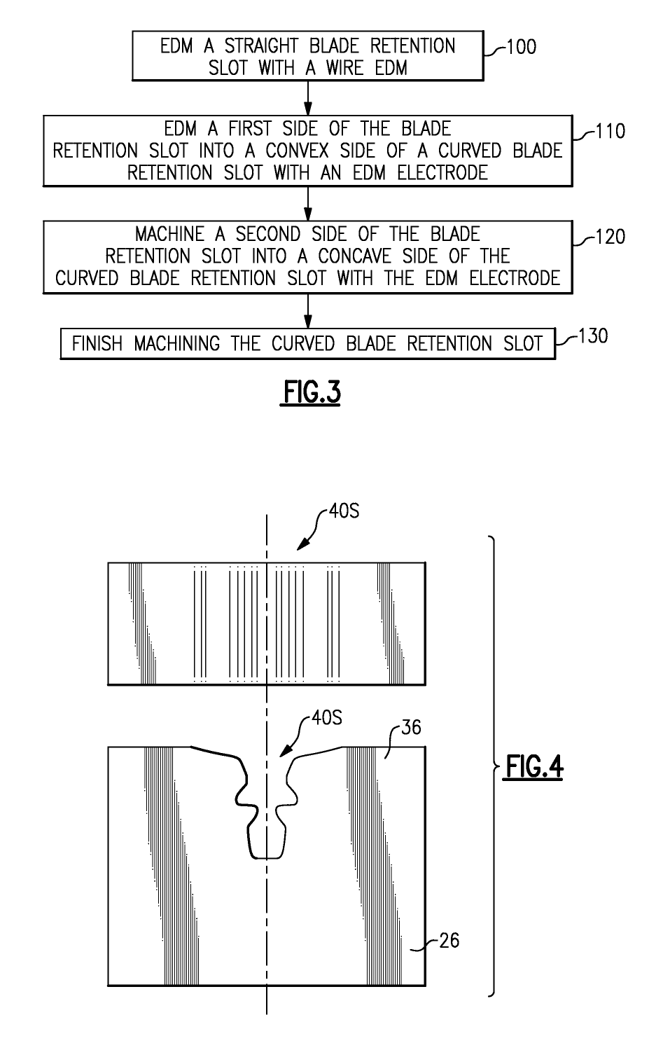

Referring to FIG. 3, the following methodology of one non-limiting embodiment may be utilized to manufacture the curved blade retention slot 40 with an electron discharge machining (EDM) process which facilitates producing accurate geometry and minimal distortion. The application of EDM machining according to the disclosure herein produces the curved blade retention slot 40 to facilitate attachment designs in highly cambered turbine airfoils to minimize platform overhang and optimize stress distribution without an increase in manufacturing cost.

EDM machining according to the disclosure herein generates the curved blade retention slot 40 with minimum thermal effects on the curved blade retention slot 40 surface. The thermal effect from EDM machining according to this disclosure are generally less than 0.002 inches (0.058 mm) which is readily removed during final surface treatment such as through, for example only, super abrasive machining. There is substantially no microstructure evolution below this depth due to the very low cutting force generation and high rate of cooling. The surface hardness also is not substantially changed from the bulk hardness.

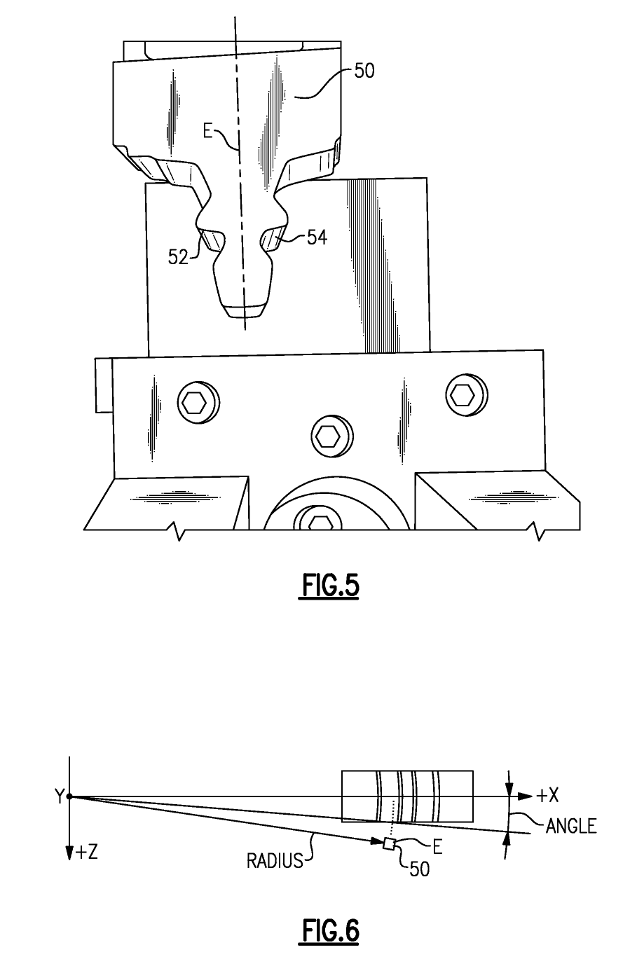

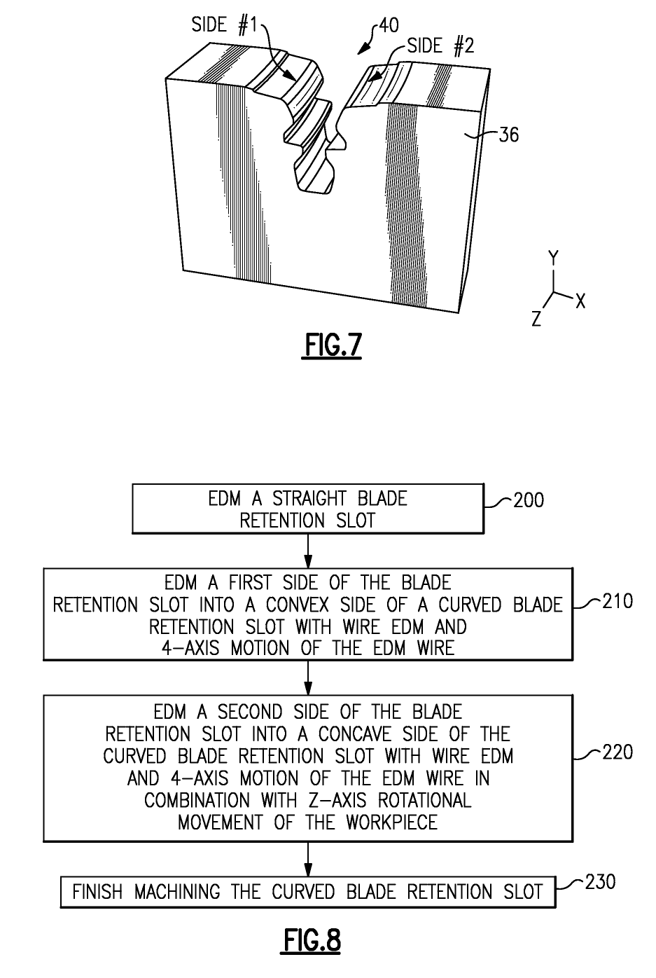

In step 100 of FIG. 3, a straight blade retention slot 40S (FIG. 4) is initially machined through the rotor disk 26. In one non-limiting embodiment, an EDM wire (not shown) is utilized to machine the straight blade retention slot 40S. That is, the straight blade retention slot 40S is machined through the rim 36 of the rotor disk 26 prior to the curvature of each side of the curved blade retention slot 40 being EDM machined therein with an EDM electrode 50 (FIG. 5). Rough machining of the straight blade retention slot 40S facilitates an intact removal of the attachment shape which increase the value of the recycled material by upwards of twenty times. The straight blade retention slot 40S may be defined by a wire EDM path to leave the minimum required material to be finished with a Die-Sinking EDM process with the EDM electrode 50 in this non-limiting embodiment.

Referring to FIG. 5, the EDM electrode 50 with a final curvature on each side 52, 54 produces the curved blade retention slot 40. The EDM electrode 50 may be fabricated from material such as, but not limited to, graphite. In this non-limiting embodiment, a convex side (side #1) and a concave side (side #2) is generated in steps 110 and 120 of FIG. 3 through movement of the EDM electrode 50 along the X-Z path. That is, the curvature on each side 52, 54 of the EDM electrode 50 corresponds with the desired convex side (side #1) and concave side (side #2) of the curved blade retention slot 40 when the EDM electrode 50 is moved along an X-Z path.

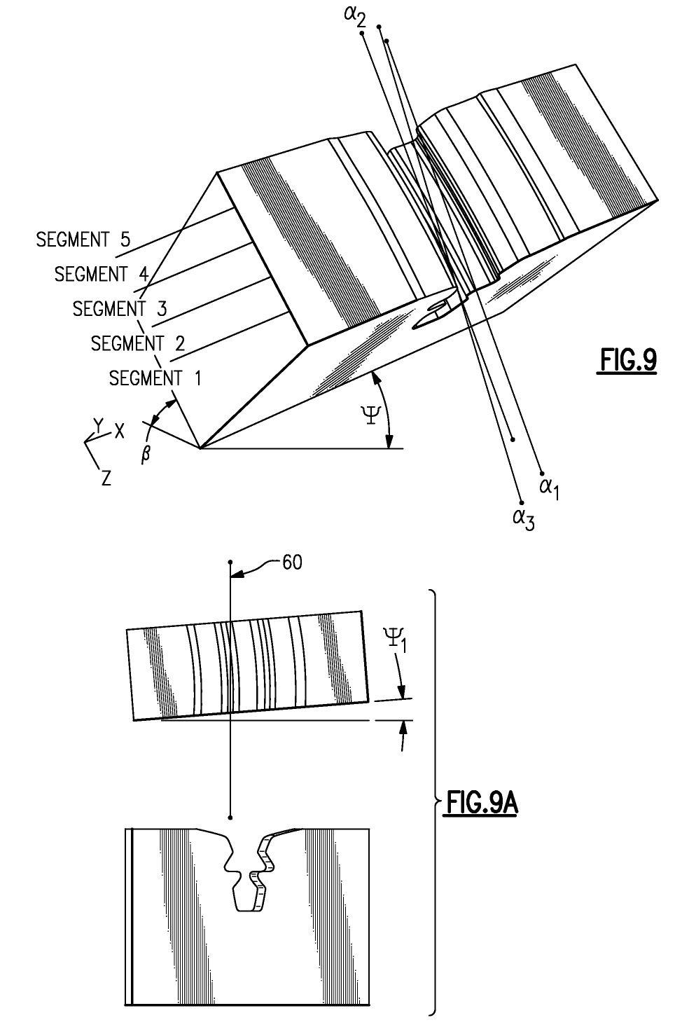

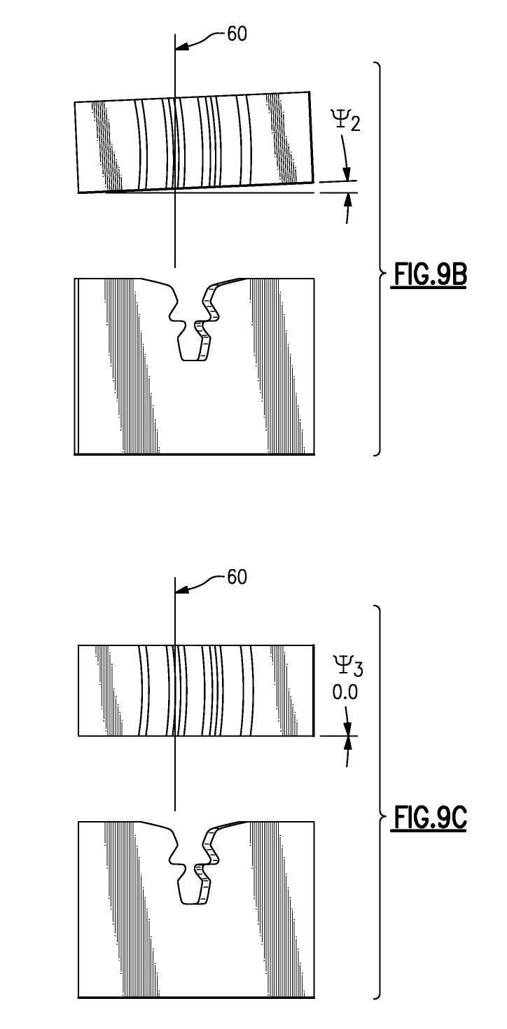

Referring to FIG. 6, the X-Z path is determined for the EDM electrode 50 such that the final curvature on each side of the curved blade retention slot 40 (FIG. 7) is generated. The X-Z path may be generally defined by a radius of movement for the EDM electrode 50 in combination with the curvature on each side 52, 54 of the EDM electrode 50 to generate the curved blade retention slot 40. Each side of the curved blade retention slot 40 may require a different path or radius of motion for the EDM electrode 50.

In one non-limiting embodiment, the EDM electrode 50 is moved along a radius and rotated about the Y-axis of the EDM electrode 50. That is, the X-Z arcuate path may be coupled with rotation of the EDM electrode 50 as the EDM electrode 50 is moved along the path to produce the desired convex side (side #1) and concave side (side #2) of the curved blade retention slot 40. This motion roughs the curved blade retention slot 40 to facilitate minimal affect to surface microstructure and/or slot distortion of the material such as a nickel super-alloy turbine disk. Whereas material removal rate is less than that achieved by a broaching process, EDM facilitates reducing scrapping of material such that the value of recycled material is increased. In addition, cost and number of tooling required for finish machine (step 130) the slot is much less than known processes.

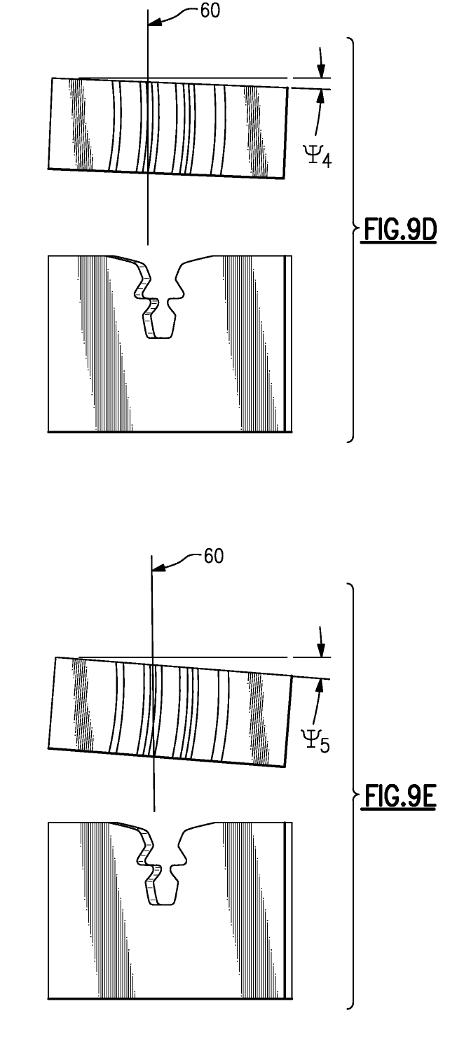

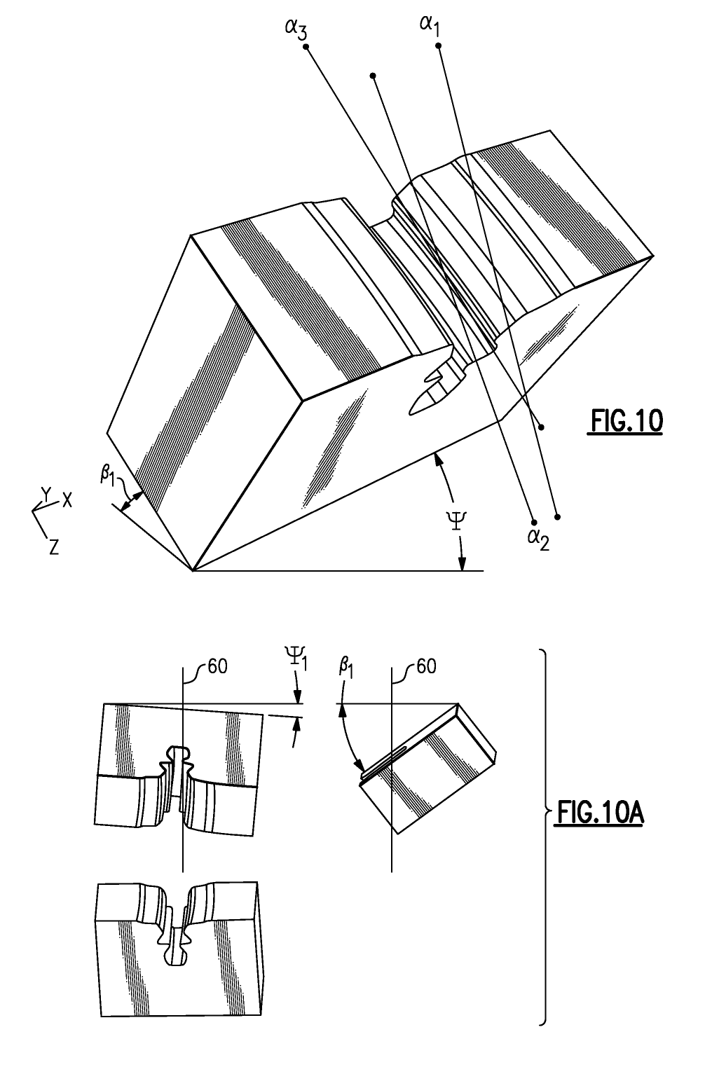

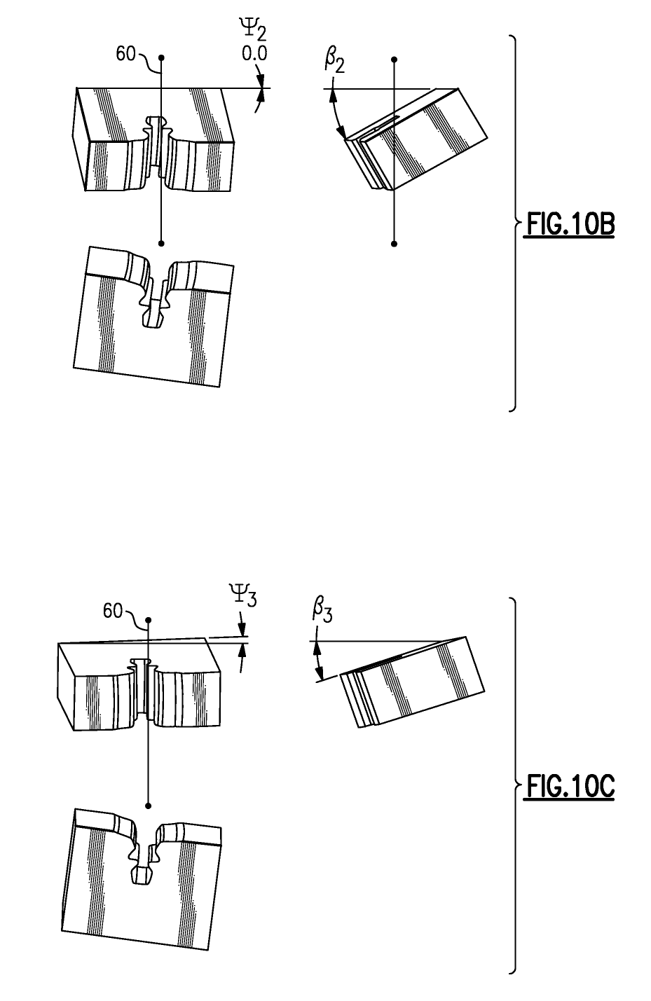

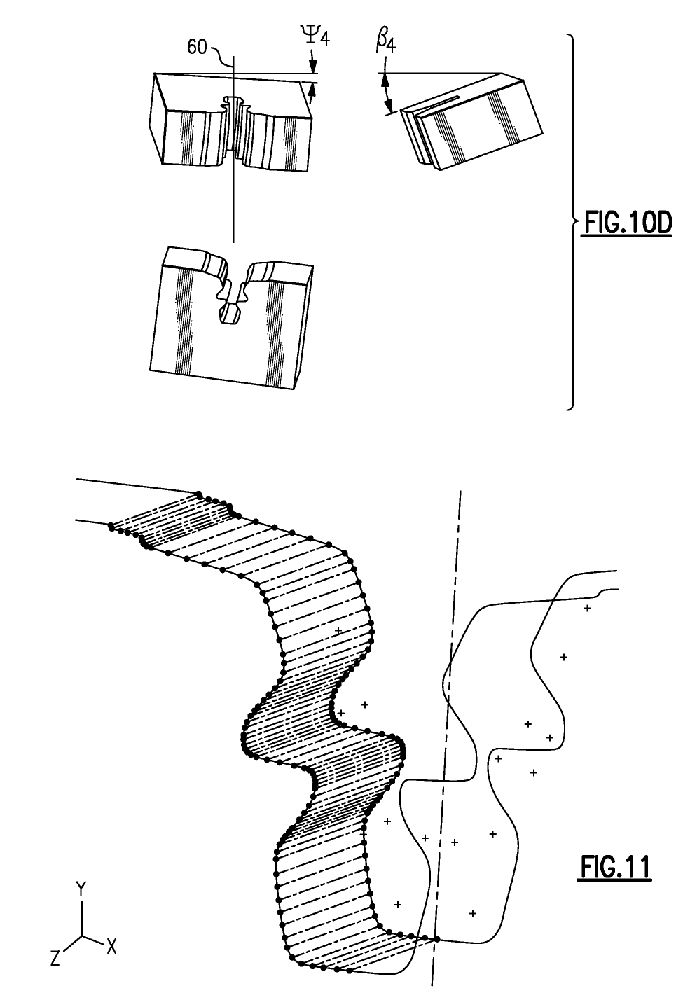

Referring to FIG. 8, the methodology of another non-limiting embodiment may be utilized to manufacture the curved blade retention slot 40. In step 200, the straight blade retention slot 40S (FIG. 4) in this non-limiting embodiment is also initially machined through the rotor disk 26 prior to the curvature of each side of the curved blade retention slot 40 being EDM machined therein with an EDM wire 60 (FIGS. 9-10D).

Referring to FIG. 9, the desired curvature of the convex side (side #1) is induced on one side of the straight blade retention slot 40S in step 210 of FIG. 8. The curved blade retention slot 40 may be discritized into several segments such as segments 1-5 (also illustrated in FIGS. 9A-9E) along the Z-axis in response to the desired curvature accuracy and the material thickness that is to remain for the finish processes steps. It should be understood that any number of segments may be defined to generate the desired curvature accuracy.

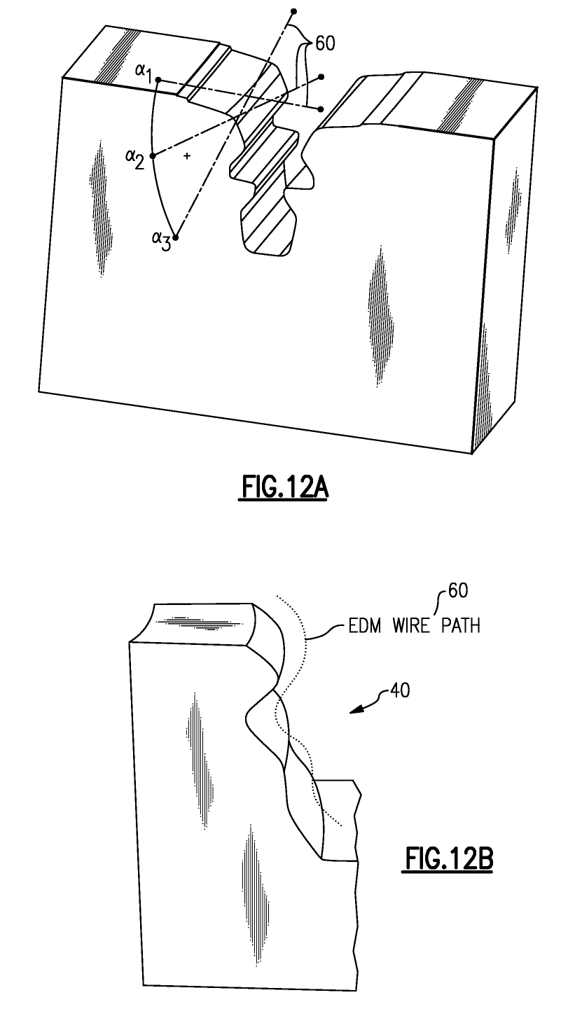

The curved blade retention slot 40 may also be discritized in the Y-direction (FIG. 1 1) such that the wire tilt angle α, such as α₁, α₂, or α₃, (also illustrated in FIG. 12A) may be calculated for each segment (FIGS. 9A-9E) as the EDM wire 60 moves in a desired feed direction (FIG. 12B) to generate the side #1 curvature. The EDM wire path in one non-limiting embodiment is in the Y-direction toward the valley of the blade retention slot 40 to generally follow the contours of the straight blade retention slot 40S for each of the segments, for example, five in this non limiting embodiment (FIGS. 9A-9E). As the EDM wire 60 moves between the Z-direction segments and generally along the Y-direction path, the EDM wire 60 may also tilt (FIG. 12A) to prevent EDM wire 60 interference and clashing with the workpiece surface during EDM machining of the curved blade retention slot 40. Both 3rd and 4th axis motion for the EDM wire 60 and the wire tilt angles a along the X-Z plane for each Y axis value are used to generate side #1 of the curved blade retention slot 40 (FIGS. 12A and 12B).

In step 220 of FIG. 8, side #2 of the curved blade retention slot 40 is machined generally as side #1 in combination with an angular increment of the straight blade retention slot 40S. That is, the 4-axis movement capability of the EDM wire is combined with a 2-axis rotational movement of the workpiece holder (not shown) to generate a 5-axis motion to produce the concave side #2 of the curved blade retention slot 40 (FIGS. 10A-10D). That is, the work piece rotates in 3 axes while the other 2 rotational angles are generated by the EDM wire head. The 5-axis motion process also includes one extra indexing motion to index the workpiece to manufacture the next slot about the disk 26. by a rotational index of the disk 26 about axis X (FIG. 2)

The EDM wire path is generated and utilized to generate all curved blade retention slots 40 on the disk 26. Software is utilized to generate the EDM wire path and synchronization of the EDM wire path with angular increment of the straight blade retention slot 40S. The EDM wire tilt angle α is predicted by connecting a representative line between each two points on the discritized surfaces. That is, the workpiece is angularly incremented or rotated to facilitate preventing EDM wire 60 interference and clashing with the workpiece surface during EDM machining of the curved blade retention slot 40.

It should be noted that a computing device with software such as Unigraphics CAD Design software can be used to implement various functionality, such as that attributable to the EDM wire path, EDM die path and workholder path movement to synchronize the EDM wire path, EDM die path and the workholder tilt to facilitate preventing EDM wire interference and clashing with the workpiece surface during EDM machining of the curved blade retention slot 40. In terms of hardware architecture, such a computing device can include a processor, memory, and one or more input and/or output (I/O) device interface(s) that are communicatively coupled via a local interface. The local interface can include, for example but not limited to, one or more buses and/or other wired or wireless connections. The local interface may have additional elements, which are omitted for simplicity, such as controllers, buffers (caches), drivers, repeaters, and receivers to enable communications. Further, the local interface may include address, control, and/or data connections to enable appropriate communications among the aforementioned components.

The processor may be a hardware device for executing software, particularly software stored in memory. The processor can be a custom made or commercially available processor, a central processing unit (CPU), an auxiliary processor among several processors associated with the computing device, a semiconductor based microprocessor (in the form of a microchip or chip set) or generally any device for executing software instructions.

The memory can include any one or combination of volatile memory elements (e.g., random access memory (RAM, such as DRAM, SRAM, SDRAM, VRAM, etc.)) and/or nonvolatile memory elements (e.g., ROM, hard drive, tape, CD-ROM, etc.). Moreover, the memory may incorporate electronic, magnetic, optical, and/or other types of storage media. Note that the memory can also have a distributed architecture, where various components are situated remotely from one another, but can be accessed by the processor.

The software in the memory may include one or more separate programs, each of which includes an ordered listing of executable instructions for implementing logical functions. A system component embodied as software may also be construed as a source program, executable program (object code), script, or any other entity comprising a set of instructions to be performed. When constructed as a source program, the program is translated via a compiler, assembler, interpreter, or the like, which may or may not be included within the memory.

The Input/Output devices that may be coupled to system I/O Interface(s) may include input devices, for example but not limited to, a keyboard, mouse, scanner, microphone, camera, proximity device, etc. Further, the Input/Output devices may also include output devices, for example but not limited to, a printer, display, etc. Finally, the Input/Output devices may further include devices that communicate both as inputs and outputs, for instance but not limited to, a modulator/demodulator (modem; for accessing another device, system, or network), a radio frequency (RF) or other transceiver, a telephonic interface, a bridge, a router, etc.

When the computing device is in operation, the processor can be configured to execute software stored within the memory, to communicate data to and from the memory, and to generally control operations of the computing device pursuant to the software. A specially developed Computer aided manufacture software in memory, in whole or in part, is read by the processor, perhaps buffered within the processor, and then executed.

It should be understood that like reference numerals identify corresponding or similar elements throughout the several drawings. It should also be understood that although a particular component arrangement is disclosed in the illustrated embodiment, other arrangements will benefit from the instant invention.

Although particular step sequences are shown, described, and claimed, it should be understood that steps may be performed in any order, separated or combined unless otherwise indicated and will still benefit from the present invention.

The foregoing description is exemplary rather than defined by the limitations within. Many modifications and variations of the present invention are possible in light of the above teachings. The disclosed embodiments of this invention have been disclosed, however, one of ordinary skill in the art would recognize that certain modifications would come within the scope of this invention. It is, therefore, to be understood that within the scope of the appended claims, the invention may be practiced otherwise than as specifically described. For that reason the following claims should be studied to determine the true scope and content of this invention.

What is claimed:

1. A method of machining a blade retention slot for a gas turbine engine comprising:
electron discharge machining a straight blade retention slot; and
electron discharge machining at least one side of the straight blade retention slot to generate a curved side of the blade retention slot.

2. A method as recited in claim 1, further comprising:
electron discharge machining the curved side of the blade retention slot into a convex side.

3. A method as recited in claim 2, further comprising:
separating the at least one side of the straight blade retention slot into a multiple of segments along a Y-axis; and
defining a wire tilt angle for each of the multiple of segments in which a wire tilt angle is defined along an X-Z plane for each segment along the Y-axis.

4. A method as recited in claim 1, further comprising:
electron discharge machining the curved side of the blade retention slot into a concave side.

5. A method as recited in claim 4, further comprising:
separating the at least one side of the straight blade retention slot into a multiple of segments along a Y-axis;
defining a wire tilt angle for each of the multiple of segments in which a wire tilt angle is defined along an X-Z plane for each segment along the Y-axis; and
angularly incrementing the straight blade retention slot in association with the wire tilt angle.

6. A method of machining a blade retention slot for a gas turbine engine comprising:
electron discharge machining a straight blade retention slot;
electron discharge machining a first side of the straight blade retention slot into a convex side of a curved blade retention slot; and
electron discharge machining a second side of the straight blade retention slot into a concave side of the curved blade retention slot.

7. A method as recited in claim 6, further comprising:
separating the first side of the straight blade retention slot into a multiple of segments along a Y-axis; and
defining a wire tilt angle for each of the multiple of segments in which a wire tilt angle is defined along an X-Z plane for each segment along the Y-axis.

8. A method as recited in claim 6, further comprising:
separating the second side of the straight blade retention slot into a multiple of segments along a Y-axis;
defining a wire tilt angle for each of the multiple of segments in which the wire tilt angle is defined along an X-Z plane for each segment along the Y-axis; and
angularly incrementing the straight blade retention slot in association with the wire tilt angle.

9. A method as recited in claim 6, further comprising:
electron discharge machining the straight blade retention slot with an electron discharge machining (EDM) wire.

10. A method as recited in claim 9, further comprising:
electron discharge machining the first side of the straight blade retention slot with an electron discharge machining (EDM) wire; and
electron discharge machining the second side of the straight blade retention slot with an electron discharge machining (EDM) wire.

11. A method as recited in claim 9, further comprising:
electron discharge machining the first side of the straight blade retention slot with an electron discharge machining (EDM) electrode; and
electron discharge machining the second side of the straight blade retention slot with the electron discharge machining (EDM) electrode.

12. A method as recited in claim 11, further comprising:
moving the (EDM) electrode in an arcuate path through the straight blade retention slot to machine the convex side of the curved blade retention slot.

13. A method as recited in claim 11, further comprising:
moving the (EDM) electrode in an arcuate path through the straight blade retention slot to machine the concave side of the curved blade retention slot.

14. A method as recited in claim 9, further comprising:
electron discharge machining the first side of the straight blade retention slot with an electron discharge machining (EDM) concave curved electrode; and
electron discharge machining the second side of the straight blade retention slot with the electron discharge machining (EDM) convex curved electrode.
